(19) United States
(12) Patent Application Publication
(10) Pub. No.: US 2024/0331045 A1
(43) Pub. Date: Oct. 3, 2024

(54) EVENT REPLAY FOR DYNAMIC EVENT PROCESSING

(71) Applicant: Apple Inc., Cupertino, CA (US)

(72) Inventors: Sarah GROSS, Valley Stream, NY (US); Chi Proeng DOV, Cupertino, CA (US); Jian LV, Oakland Gardens, NY (US); Joe M. LIN, Jersey City, NJ (US); Jonathan L. CUTLER, Brooklyn, NY (US); Maria Y. XIA, Brooklyn, NY (US); Natalie A. ZAMANI, Cupertino, CA (US); Petru URSU, Holmdel, NJ (US); Sangeetha SRIRAM, Saratoga, CA (US); Thomas PURCHAS, London (GB); Wei-en TSAI, London (GB)

(21) Appl. No.: 18/497,973

(22) Filed: Oct. 30, 2023

Related U.S. Application Data
(60) Provisional application No. 63/455,247, filed on Mar. 28, 2023.

(51) Int. Cl. G06Q 40/06

(52) U.S. Cl. CPC G06Q 40/06

(57) ABSTRACT

The subject system may be implemented by a processor circuit configured to receive, from a user device, a request to initialize an event-driven product, initialize, responsive to the request, a product state data structure for the event-driven product, receive a plurality of events corresponding to the event-driven product, each respective event of the plurality of events comprising a respective state change and a respective effective time; store each respective state change in the product state data structure in association with the corresponding respective effective time, process the respective state changes in the product state data structure based at least in part on the respective effective times to determine a current state of the event-driven product, receive a request for the current state of the event-driven product, and provide, in response to the request, the current state of the event-driven product.

### CROSS-REFERENCE TO RELATED APPLICATIONS

The present application claims the benefit of U.S. Provisional Patent Application Ser. No. 63/455,247, entitled “EVENT REPLAY FOR DYNAMIC EVENT PROCESSING,” filed Mar. 28, 2023, which is hereby incorporated herein by reference in its entirety and made part of the present U.S. Utility Patent Application for all purposes.

### TECHNICAL FIELD

The present description generally relates to event-driven products provided on electronic devices and, more particularly, to dynamic event processing for event-driven products.

### BACKGROUND

A service provider may offer products and/or features to users on electronic devices. In some examples, the products and/or services may involve one or more third parties, e.g., in addition to the service provider.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment in which event replay for dynamic event processing may be implemented, in accordance with one or more implementations.

FIG. 2 depicts an example server that may implement the subject methods and systems, in accordance with one or more implementations.

FIG. 3 depicts a flow diagram of an example process for dynamic event processing, in accordance with one or more implementations.

FIG. 4 depicts an example checkout interface on a mobile application, in accordance with one or more implementations.

FIG. 5 depicts an example scheduler and event-driven product controller, in accordance with one or more implementations.

FIG. 6 depicts an example event-driven product controller of FIG. 5 as well as an example calculation engine and transaction register, in accordance with one or more implementations.

FIG. 7 depicts an example electronic system with which aspects of the present disclosure may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In one approach to maintaining a financial product (e.g., a loan), a service provider may rely on databases or other data management systems to maintain a current state of the financial product, such as the outstanding balance on a loan, and the like. When the current state is to be updated, the service provider may directly modify the database to reflect any changes to the financial product, such as account balances, interest rates, and payment histories. Although this approach may seem intuitive, challenges are presented when previous states become involved. For example, backdating and reversing payments may be inefficient and error-prone when only the current state is maintained.

Aspects of the subject technology relate to a system for maintaining an event-driven product, such as a financial product, that utilizes event sourcing to maintain a list of events related to the financial product rather than maintaining the current state of the financial product. The system takes in a set of events as input and performs financial-product-specific computing logic on the set of events to derive a current state of the financial product. The logic is implemented by a calculation engine and is versioned, meaning that events can be replayed idempotently while supporting changes to the computing logic over time. In this way, the system provides, for example, the following advantages: (i) the subject technology allows support for cases like payment network reversals and manual backdating without reverse-engineering calculation logic, which may be error-prone (e.g., the original event can be omitted from the log and/or replaced with a modified event); (ii) audit history: the subject technology provides the ability to track all events that occurred during the life of a financial product; (iii) consistent processing: processing can be consistently reproduced because it is event-driven; (iv) effective failure handling: if something fails, bug fixes can be applied en-masse by updating the computing logic version of events; (v) debugging: the subject technology provides the ability to more easily identify the root cause of issues since each event and its details are stored.

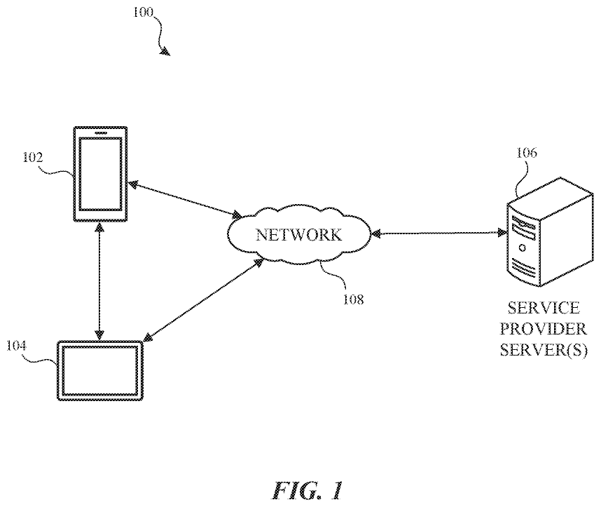

FIG. 1 illustrates an example network environment 100 for mobile payment, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include a user device 102, one or more other electronic devices (e.g., merchant device 104), and one or more servers (e.g., service provider server 106). The network 108 may communicatively (directly or indirectly) couple the user device 102, merchant device 104, and/or the service provider server 106. In one or more implementations, the network 108 may be an interconnected network of devices that may include, or may be communicatively coupled to, the Internet. For explanatory purposes, the network environment 100 is illustrated in FIG. 1 as including the user device 102, merchant device 104, and the service provider server 106; however, the network environment 100 may include any number of electronic devices and/or any number of servers communicatively coupled to each other directly or via the network 108.

The user device 102 may be, for example, a wearable device such as a watch, a band, and the like, a desktop computer, a portable computing device such as a laptop computer, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the user device 102 is depicted as a smartphone. The user device 102 may be registered to a user account with the service provider server 106.

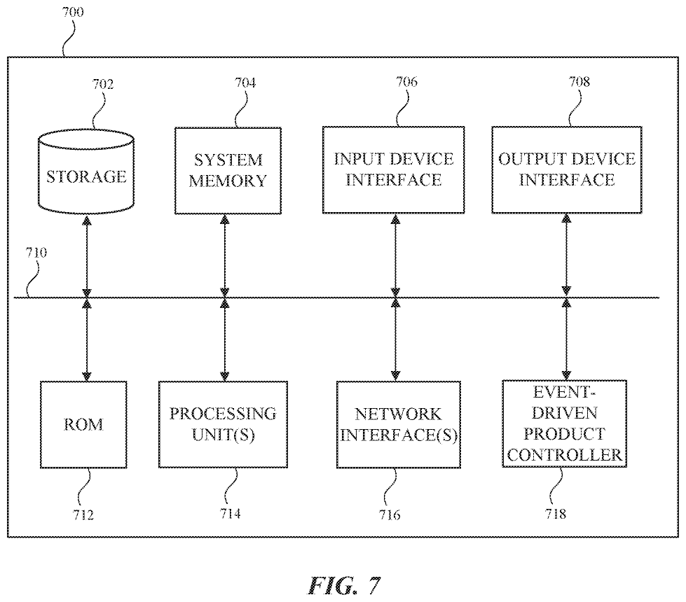

The merchant device 104 may be a similar electronic device as described with respect to the user device 102. In FIG. 1, by way of example, the merchant device 104 is depicted as a tablet. The merchant device 104 may be, and/or may include all or part of, the electronic system discussed below with respect to FIG. 7. The merchant device 104 may be configured to perform transactions with digital payment credentials, such as from the user device 102.

The service provider server 106 may listen for and/or receive indications of events from an electronic device (e.g., the user device 102 and/or the merchant device 104), and/or from other servers and/or other devices, such as financial institution servers and the like. Events may include transactions, interest accruals, payment reversals, and any other action relating to a financial product. The service provider server 106 may utilize the events to maintain financial products. For example, a financial product may have an initial state, which may include, for example, a balance and an interest rate. The initial state of the financial product may be followed by an event that modifies the initial state to form a subsequent state. Each subsequent event may be used to modify the state as modified by the preceding event. In some implementations, the service provider server 106 includes one or more application-specific modules (e.g., plugins, services, frameworks, etc.) that perform operations for a respective application (e.g., calculating a state change based on an event).

The service provider server 106 may store account information (e.g., user account, usernames/handles, or any other account-specific data) associated with the user device 102 and/or users thereof and/or users associated therewith. In one or more implementations, one or more servers (e.g., the service provider server 106) may provide a cached version of the current state of a financial product to a device (e.g., the user device 102), for example, to view a balance of a financial product by an application or operating system of the device. The service provider server 106 may be, and/or may include all or part of, the electronic system discussed below with respect to FIG. 7.

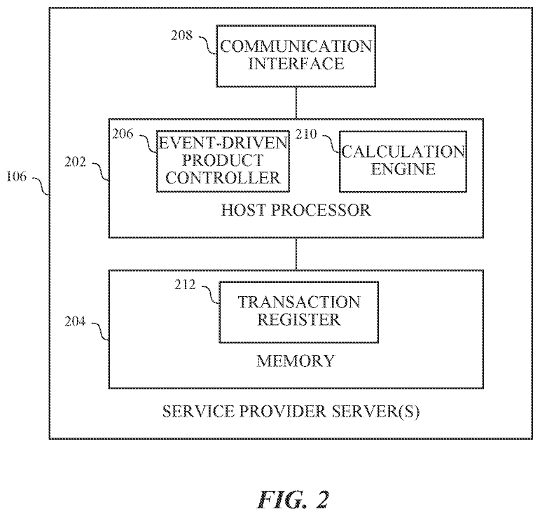

FIG. 2 depicts an example service provider server 106 that may implement the subject methods and systems, in accordance with one or more implementations. For explanatory purposes, FIG. 2 is primarily described herein with reference to the service provider server 106 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The service provider server 106 may include one or more of a host processor 202, a memory 204, an event-driven product controller 206, and/or a communication interface 208. The host processor 202 may include suitable logic, circuitry, and/or code that enable processing data and/or controlling operations of the service provider server 106. In this regard, the host processor 202 may be enabled to provide control signals to various other components of the service provider server 106. The host processor 202 may also control transfers of data between various portions of the service provider server 106. The host processor 202 may further implement an operating system or may otherwise execute code to manage operations of the service provider server 106.

The event-driven product controller 206 may include suitable logic, circuitry, and/or code for storing events of one or more event-driven products, such as financial products, and generating a state for a respective event-driven product based on its events. The event-driven product controller 206 may maintain an event log, which may be append-only and contain data necessary to process an event. When a new event is processed (e.g., by the calculation engine 210), the event-driven product controller 206 may direct each event to be processed (e.g., starting from the first event) such that the current state (e.g., the state with the new event) is re-generated from scratch. As each event is being processed, the event-driven product controller 206 may store intermediary states (e.g., states between the initial and current state) as the current state is generated. The event-driven product controller 206 may also or instead store at least part of the current state to reference in the scenario where the current state is desired but does not need to be re-generated, such as when a user wants to view the current balance of the financial product.

The calculation engine 210 may include suitable logic, circuitry, and/or code for receiving an event as input and performing one or more calculations on the event to generate an output. The input may include at least part of the event, such as the event details. The event details may include and/or may indicate, for example, logic for appropriately processing a state change corresponding to the event. The type of calculations to be performed on the input may be determined based on the engine version specified in the event, which may allow for bugs in the calculation engine 210 to be resolved after the event has been created. In this way, the calculation engine 210 may be versioned, allowing for more flexibility and accuracy in determining the state of the financial product. The type of calculations to be performed on the input may also be determined based on the type of the event. The output of the calculations may be stored by the event-driven product controller 206.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store user location data, track data (e.g., lane information), exercise data (e.g., biometrics), account data, and any other data generated in the course of performing the processes described herein.

The memory 204 may include one or more transaction registers 212. A transaction register 212 may include suitable logic, circuitry, and/or code for maintaining a timeline of events for one or more financial products, which may represent the state of the respective financial products. The timeline may include the output of the calculation engine 210 of the events. Where the events may include details relating to the event and how to calculate the next state based on details in the event (e.g., interest rates and calculation engine 210 version), the timeline may include the financial effects of the events. For example, a single loan disbursement may result in a single event, which may include the interest rate and effective date, and the processing of the event may have multiple financial effects as determined by the appropriate version of the calculation engine 210, which may include increasing a balance on an account, transferring funds, and assessing a lending fee.

The communication interface 208 may include suitable logic, circuitry, and/or code that enables wired or wireless communication, such as between the service provider server 106 and the service provider server 106. The communication interface 208 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the event-driven product controller 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

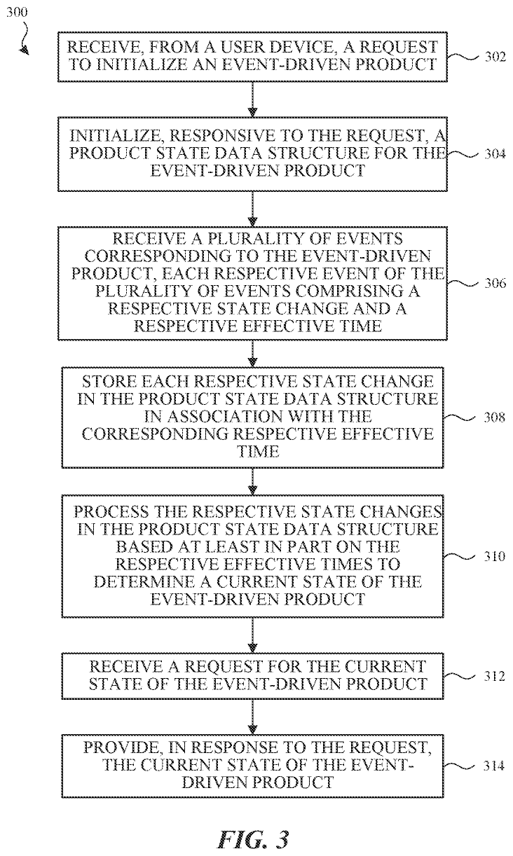

FIG. 3 depicts a flow diagram of an example process 300 for dynamic event processing, in accordance with one or more implementations. For explanatory purposes, the process 300 is primarily described herein with reference to the user device 102, the merchant device 104, and the service provider server 106 of FIG. 1. However, the process 300 is not limited to the user device 102, the merchant device 104, or the service provider server 106, and one or more blocks of the process 300 may be performed by one or more other components of the service provider server 106, and/or by other suitable devices. Further, for explanatory purposes, the blocks of the process 300 are described herein as occurring sequentially or linearly. However, multiple blocks of the process 300 may occur in parallel. In addition, the blocks of the process 300 need not be performed in the order shown and/or one or more blocks of the process 300 need not be performed and/or can be replaced by other operations.

At block 302, a system (e.g., the service provider server 106) may receive a request to initialize an event-driven product. For example, the request may be from a user device (e.g., the user device 102) and the event-driven product may be a financial product such as a “pay later” loan. In one or more implementations, a user interacting with the user device 102 may request a particular financial product, such as a “pay later” product where the user is provided with funding for a purchase at the current time and pays back the funding for the purchase later. The service provider server 106 may receive the request to initialize the event-driven product as part of, and/or in conjunction with, the initial request from the user device for the particular financial product, and/or the service provider server 106 may receive the request to initialize the event-driven product from another server, e.g., after the user is approved/authorized for receiving the particular financial product.

At block 304, the system may initialize the event-driven product as well as a product state data structure associated with the product to maintain the state of the product. The data structure may be associated with an event-driven product controller (e.g., the event-driven product controller 206). When initializing an event-driven product, the system may create an instance of the product, which may be represented in the form of a series of events that capture the state changes of the product over time. These events may be logged and stored in a database or other persistent storage mechanism.

The system may also perform any necessary checks or validations to ensure that the product is being created correctly and meets any relevant regulatory and/or compliance requirements. This may involve verifying customer information, performing credit checks, or validating product features against a predefined set of rules. Once the product has been initialized and any necessary validations have been performed, the system may trigger a series of workflows or business processes that are associated with the product. These workflows may include actions such as onboarding the customer, setting up any necessary accounts or payments, or initiating any relevant legal or regulatory processes.

At block 306, the system may receive one or more events corresponding to the event-driven product. Each respective event of the plurality of events may include a respective state change and a respective effective time. The state change may be an action related to the event-driven product. For example, for a loan, events may include initiation, payment, reversal, and interest accrual. The effective time represents a time when the state change is to occur. This way, events may be added that can apply retroactively to perform actions such as reversals or backdating.

Events may be triggered by a variety of actions, such as user interactions, external processes, or internal processes. For example, events may be generated when a user applies for a loan, makes a payment, or changes their account settings. External processes can also generate events that trigger updates to a financial product. For instance, an event may be generated when an external credit bureau reports changes to a customer's credit score, which may trigger a recalculation of the loan's interest rate, or an event may be triggered by a reversal of a charge. Internal business processes can also generate events that update the state of a financial product. For instance, an event may be generated when a customer service representative approves a loan application or updates a customer's account information.

At block 308, the system stores each respective state change in the product state data structure. A state change of an event may include a type and one or more event details. The type of the state change may represent the type of action that was performed to trigger the event. For example, types may include initialize, payment, interest accrual, reversal, and the like. The event details may correspond to the event type. For example, when the event triggered to initiate a loan to be re-paid in installments, event details may include the number of installments and the interest rate. In one or more implementations, the event details may include indications of processing logic (e.g., version number of a calculation engine, which includes processing logic) that may affect, for example, how the event should be processed with regard to the state of the financial product.

The state change of an event may also include an engine version. The engine version specifies which version of a calculation engine (e.g., the calculation engine 210) to utilize in processing the state change. The engine version may specify a major version and a minor version. For example, major versions may indicate a significant difference between engine versions, such as new features or breaking changes. Major versions may differ between event-driven products so that any single event-driven product is calculated substantially the same way. By contrast, minor versions may include bug fixes or changes that may be introduced to products in progress.

The state change may also indicate an effective time. New events may be created but may be put into effect at a time different from when it was created. This way, events may be applied retroactively or scheduled. Thus, an event's effective time may be at, before, or after the event's created time.

At block 310, the system may process the state changes in the product state data structure to determine a current state of the event-driven product. The state changes may be ordered based at least in part on their respective effective times. For example, the state changes may be sorted in ascending order by their effective times so that the earliest effective state change may be applied first.

The system may provide the event details of one or more state changes to an engine corresponding to the engine version of the respective state change. When event details are received by the engine, the engine processes the event by updating the state of the corresponding financial product. This processing may involve a set of business rules and logic that determine how the state of the financial product should change based on the event details.

The processing of the event may include a variety of actions, such as updating the balance of a loan or credit account, recalculating interest rates, or triggering other events. The system may also generate additional events in response to the input event, which can trigger further processing and updates to the state of the event-driven product.

The timing of these state changes may depend on the specific use case and product requirements. Some state changes may be processed in real-time, while others may be queued and processed in batches at regular intervals. The frequency of state changes can also vary depending on the nature of the product and the rate of incoming events.

In one or more implementations, the outputs of the computation engine may be stored in a transaction register. The transaction register may be a log of actions that occur with respect to each event in the time specified by the event. The transaction register may represent the current state of the event-driven product. For example, each entry in the transaction register may include an amount, such as an amount paid, an amount disbursed, an amount of interest accrued, and the like, the sum of which may be the current balance of the event-driven product.

At block 312, the system may receive a request for the current state of the event-driven product. In response, the system may access, download, retrieve, generate, or otherwise acquire the current state of the event-driven product, which may include all or some of the transaction register or information derived from the transaction register (e.g., the sum of the amounts, representing the balance of the event-driven product).

At block 314, the system may provide the current state of the event-driven product. In some implementations, the system may also store at least part of the current state of the event-driven product so that the current state may be referenced without re-generating the current state. The current state may be stored until another event is triggered causing the current state to be re-generated.

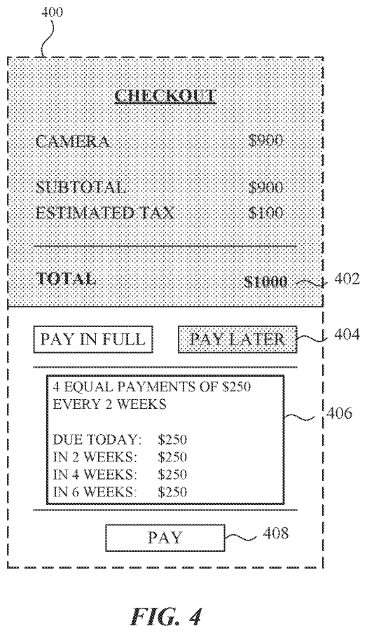

FIG. 4 depicts an example checkout interface 400 on a mobile application, in accordance with one or more implementations. The mobile application may run on the user device 102 and include one or more items purchasable by the user device 102 via the checkout interface 400. The checkout interface 400 may include a list of items to be purchased by the user, such as a camera for $900. The mobile application may calculate and the checkout interface 400 may display a total amount 402, which may be the sum of the subtotal of the items to be purchased (e.g., $900) and the estimated tax associated with the transaction (e.g., $100). The checkout interface 400 may allow the user to pay in full or “pay later,” as selected by the “pay later” button 404. To pay later, the user may, for example, provide the mobile application with a re-payment credential, which may be used to generate re-payment data. The interface 400 may also display a repayment schedule 406. The user may also provide a billing/shipping address. To proceed with the transaction, the user may press the pay button 408, which may cause the user device 102 to display further information about the transaction and/or initiate a pay later financing product and cause the creation of an event associated with the pay later financing product (e.g., initializing an event-driven product), as described above with respect to process 300.

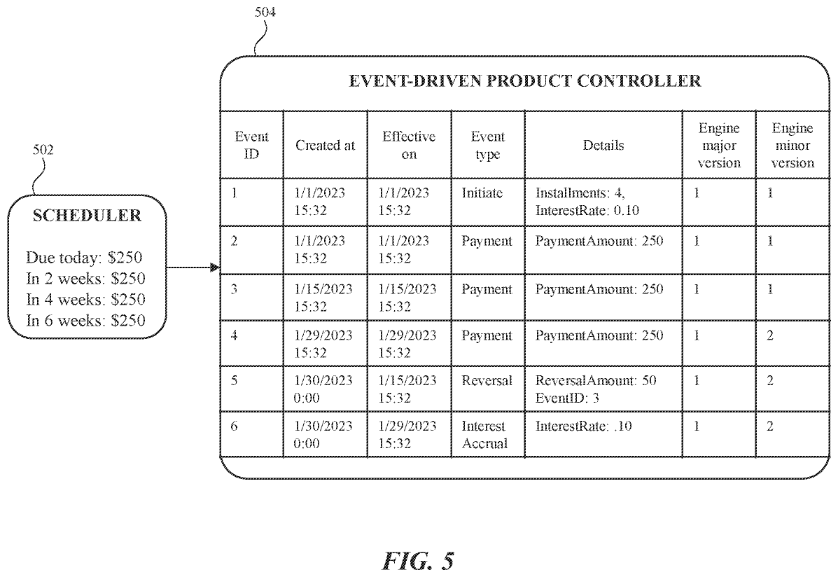

FIG. 5 depicts an example scheduler 502 and event-driven product controller 504, in accordance with one or more implementations. Events can be created in a variety of ways in an event-driven financial product. In some cases, events are created as a result of user actions, such as when a user applies for a loan or makes a payment on an existing loan. In other cases, events may be generated automatically, such as when a loan payment is due or when an account balance falls below a certain threshold. Another way events may be created through the use of a scheduler 502. A scheduler 502 can be used to generate events at specific times or intervals, which can be useful for automating certain processes in the event-driven product. For example, as shown in FIG. 5, the scheduler 502 may be used to generate events corresponding to four partial re-payments of the pay later loan described above with respect to FIG. 4.

The event-driven product controller 504 shown in FIG. 5 also corresponds to the pay later loan described above with respect to FIG. 4. The event-driven product controller 504 may maintain a list of events corresponding to the pay later loan. As shown by event ID 1, the pay later loan may have been initiated at Jan. 1, 2023 15:32 when the event was created. Event ID 1 includes an “effective on” time that is the “created at” time. Event ID 1 may also include details relating to the initiation of the pay later loan such as the number of installments (e.g., four) and the applicable interest rate (e.g., 10%). Event ID 1 may also include a major and minor version that specifies the version of a calculation engine (e.g., the calculation engine 210) to utilize in processing the state change.

Processing Event ID 1 may form the initial state of the pay later loan and cause the scheduler 502 to schedule the generation of “payment due” events (e.g., based on the details of Event ID 1) corresponding to each payment and when they are expected to be paid. When the payment date arrives, the “payment due” events may trigger a payment event for the designated amount, and if the payment is unsuccessful a penalty may be imposed. As shown in FIG. 5, the events span approximately four weeks and the scheduler 502 has caused the generation of three of the four payment due events (e.g., Event ID 2, Event ID 3, and Event ID 4), which have subsequently been paid on time. However, a reversal occurred with respect to the second payment thereby causing a reversal event (e.g., Event ID 5).

As shown by Event ID 5, payment reversals can be achieved by backdating an event in the event log. To perform a payment reversal, the event-driven product controller 504 may identify the original payment event (e.g., Event ID 3) in the event log. Then, the event-driven product controller 504 may create a new event (e.g., Event ID 5) to backdate the original payment event. The new event may have a reversal amount (e.g., $50) indicating that the payment is being reversed by that amount. This new event may be timestamped with the original payment event's timestamp (e.g., Jan. 15, 2023 15:32), effectively backdating the reversal to the original payment's transaction time. Once the backdated reversal event is added to the event log, the event-driven product controller 504 may process it in the same way as any other event, updating the state of the event-driven product accordingly, e.g., starting with the first event and reprocessing each event in sequence (such as ordered by effective date). This process of backdating an event allows for payment reversals to be handled seamlessly and efficiently, without requiring the event-driven product controller 504 to reverse-engineer the business logic or examine the final state of the event-driven product, which may introduce errors in the calculations.

In some implementations, backdating an event (e.g., Event ID 5) may trigger the creation of an interest accrual event (e.g., Event ID 6). When a backdated event is added to the event log, the event-driven product controller 504 may check to see if any events that occurred after the backdated event but before the current state of the financial product should be adjusted as a result of the backdated event. In the case of a payment reversal, for example, the event-driven product controller 504 may adjust the interest accrual events that occurred between the original payment and the payment reversal. This adjustment could be made by creating a new interest accrual event with an amount to offset the interest that should have been accrued. The new event would be timestamped (e.g., with an “effective on” timestamp) with the same timestamp as the backdated event to ensure that it is applied to the correct period. Once the interest accrual event is added to the event log, the event-driven product controller 504 may process it in the same way as any other event, updating the state of the financial product accordingly.

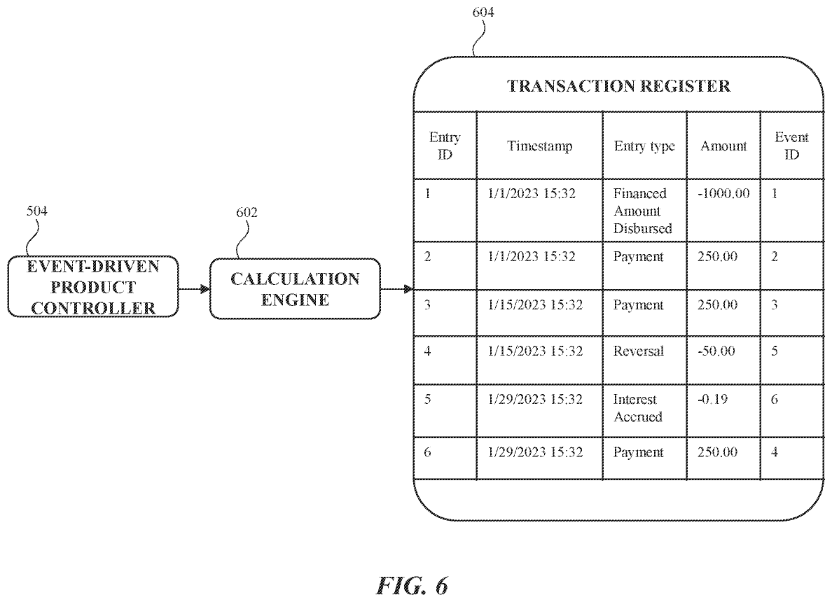

FIG. 6 depicts the event-driven product controller of FIG. 5 as well as an example calculation engine 602 and transaction register 604, in accordance with one or more implementations. As described above, the event may include an engine version (e.g., a major/minor version of calculation logic to be performed by the calculation engine 602). The engine version specifies which version of a calculation engine 602 to utilize in processing the state change. The calculation engine 602 may receive at least part of one or more events and output an appropriate value based on the current state of the event-driven product and the input. The output of the calculation engine 602 may be used to create an entry in a transaction register 604, which may be used to provide a detailed record of the activities associated with the event-driven product. The entries may correspond to the event (e.g., via an Event ID) from which they were generated by the calculation engine 602. The calculation engine 602 may also reference entries in the transaction register 604 because there may be calculations that rely on the state of the event-driven product (e.g., to obtain the current balance)

The transaction register 604 may represent the state of the event-driven product at different points in time, including the state changes made to the product. The transaction register 604 may not include the events themselves, but rather entries generated based on the events. These entries may include information such as the current state of the product, the date and time of each state change, the user or system responsible for the change, and any other relevant metadata. By maintaining the transaction register 604, actions that occurred during the life of the product can be tracked and any potential issues or discrepancies can be identified. Additionally, the transaction register 604 provides a historical record that can be used for regulatory compliance, reporting, and analysis purposes.

FIG. 7 depicts an example electronic system 700 with which aspects of the present disclosure may be implemented in accordance with one or more implementations. The electronic system 700 can be, and/or can be a part of, any electronic device for generating the features and processes described in reference to FIGS. 1-6, including but not limited to a laptop computer, tablet computer, smartphone, and wearable device (e.g., smartwatch, fitness band). The electronic system 700 may include various types of computer-readable media and interfaces for various other types of computer-readable media. The electronic system 700 includes a persistent storage device 702, a system memory 704 (and/or buffer), an input device interface 706, an output device interface 708, a bus 710, a ROM 712, one or more processing unit(s) 714, one or more network interface(s) 716, an event-driven product controller 718, and/or subsets and variations thereof.

The bus 710 collectively represents all system, peripheral, and chipset buses that communicatively connect the numerous internal devices of the electronic system 700. In one or more implementations, the bus 710 communicatively connects the one or more processing unit(s) 714 with the ROM 712, the system memory 704, and the persistent storage device 702. From these various memory units, the one or more processing unit(s) 714 retrieves instructions to execute and data to process in order to execute the processes of the subject disclosure. The one or more processing unit(s) 714 can be a single processor or a multi-core processor in different implementations.

The ROM 712 stores static data and instructions that are needed by the one or more processing unit(s) 714 and other modules of the electronic system 700. The persistent storage device 702, on the other hand, may be a read-and-write memory device. The persistent storage device 702 may be a non-volatile memory unit that stores instructions and data even when the electronic system 700 is off. In one or more implementations, a mass-storage device (such as a magnetic or optical disk and its corresponding disk drive) may be used as the persistent storage device 702.

In one or more implementations, a removable storage device (such as a floppy disk, flash drive, and its corresponding disk drive) may be used as the persistent storage device 702. Like the persistent storage device 702, the system memory 704 may be a read-and-write memory device. However, unlike the persistent storage device 702, the system memory 704 may be a volatile read-and-write memory, such as RAM. The system memory 704 may store any of the instructions and data that one or more processing unit(s) 714 may need at runtime. In one or more implementations, the processes of the subject disclosure are stored in the system memory 704, the persistent storage device 702, and/or the ROM 712. From these various memory units, the one or more processing unit(s) 714 retrieves instructions to execute and data to process in order to execute the processes of one or more implementations.

The bus 710 also connects to the input device interfaces 706 and output device interfaces 708. The input device interface 706 enables a user to communicate information and select commands to the electronic system 700. Input devices that may be used with the input device interface 706 may include, for example, alphanumeric keyboards, touch screens, and pointing devices. The output device interface 708 may enable the electronic system 700 to communicate information to users. For example, the output device interface 708 may provide the display of images generated by electronic system 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 710 also connects to event-driven product controller 718. The event-driven product controller 718 may include hardware and/or software that performs similar functions as described with respect to the event-driven product controller 206, described above. The event-driven product controller 718 may be associated with one or more calculation engines (e.g., calculation engine 210) for executing logic, code, and/or the like, on one or more events. The event-driven product controller 718 may also be associated with one or more event registers (e.g., transaction register 212) for storing a timeline associated with a current state of a financial product and/or outputs of a calculation engine with respect to one or more events.

Finally, as shown in FIG. 7, the bus 710 also couples the electronic system 700 to one or more networks and/or to one or more network nodes through the one or more network interface(s) 716. In this manner, the electronic system 700 can be a part of a network of computers (such as a local area network, a wide area network, an Intranet, or a network of networks, such as the Internet). Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, from a user device, a request to initialize an event-driven product;
initializing, responsive to the request, a product state data structure for the event-driven product;
receiving a plurality of events corresponding to the event-driven product, each respective event of the plurality of events comprising a respective state change and a respective effective time;
storing each respective state change in the product state data structure in association with the corresponding respective effective time;
processing the respective state changes in the product state data structure based at least in part on the respective effective times to determine a current state of the event-driven product;
receiving a request for the current state of the event-driven product; and
providing, in response to the request, the current state of the event-driven product.

2. The method of claim 1, wherein each respective event comprises an event detail and an engine version.

3. The method of claim 2, wherein processing the respective state changes in the product state data structure comprises:
providing the event detail of the respective event comprising the respective state change to an engine corresponding to an engine version of the respective event; and
receiving, from the engine, an output based on the event detail, wherein the output comprises at least part of the current state.

4. The method of claim 2, wherein the respective event comprise a type and the event detail comprises processing logic corresponding to the type.

5. The method of claim 1, wherein the current state comprises an amount.

6. The method of claim 1, further comprising:
storing at least part of the current state of the event-driven product for subsequent retrieval.

7. The method of claim 1, wherein processing the respective state changes comprises:
ordering the respective state changes based at least in part on the respective effective times; and
sequentially processing the ordered respective state changes.

8. The method of claim 1, wherein the event-driven product comprises a financial product and at least one of the plurality of events comprises one or more of an initiation, payment, reversal, or interest accrual.

9. A system comprising:
a memory; and
a processor circuit configured to:
receive, from a user device, a request to initialize an event-driven product;
initialize, responsive to the request, a product state data structure for the event-driven product;
receive a plurality of events corresponding to the event-driven product, each respective event of the plurality of events comprising a respective state change and a respective effective time;
store each respective state change in the product state data structure in association with the corresponding respective effective time;
process the respective state changes in the product state data structure based at least in part on the respective effective times to determine a current state of the event-driven product;
receive a request for the current state of the event-driven product; and
provide, in response to the request, the current state of the event-driven product.

10. The system of claim 9, wherein each respective event comprises an event detail and an engine version.

11. The system of claim 10, wherein the processor circuit is configured to process the respective state changes in the product state data structure by:
providing the event detail of the respective event comprising the respective state change to an engine corresponding to an engine version of the respective event; and
receiving, from the engine, an output based on the event detail, wherein the output comprises at least part of the current state.

12. The system of claim 10, wherein the respective event comprise a type and the event detail comprises processing logic corresponding to the type.

13. The system of claim 9, wherein the current state comprises an amount.

14. The system of claim 9, wherein the processor circuit is further configured to:
store at least part of the current state of the event-driven product for subsequent retrieval.

15. The system of claim 9, wherein the processor circuit is configured to process the respective state changes by:
ordering the respective state changes based at least in part on the respective effective times; and
sequentially processing the ordered respective state changes.

16. The system of claim 9, wherein the event-driven product comprises a financial product and at least one of the plurality of events comprises one or more of an initiation, payment, reversal, or interest accrual.

17. A non-transitory computer-readable medium comprising computer-readable instructions that, when executed by a processor, cause the processor to perform one or more operations comprising:
receiving, from a user device, a request to initialize an event-driven product;
initializing, responsive to the request, a product state data structure for the event-driven product;
receiving a plurality of events corresponding to the event-driven product, each respective event of the plurality of events comprising a respective state change and a respective effective time;
storing each respective state change in the product state data structure in association with the corresponding respective effective time;
processing the respective state changes in the product state data structure based at least in part on the respective effective times to determine a current state of the event-driven product;
receiving a request for the current state of the event-driven product; and
providing, in response to the request, the current state of the event-driven product.

18. The non-transitory computer-readable medium of claim 17, wherein each respective state change comprises an event detail and an engine version.

19. The non-transitory computer-readable medium of claim 18, wherein processing the respective state changes in the product state data structure comprises:
providing the event detail of the respective event comprising the respective state change to an engine corresponding to an engine version of the respective event; and
receiving, from the engine, an output based on the event detail, wherein the output comprises at least part of the current state.

20. The non-transitory computer-readable medium of claim 18, wherein the respective event comprise a type and the event detail comprises processing logic corresponding to the type.
